(19) United States
(12) Patent Application Publication
(10) Pub. No.: US 2026/0043986 A1
(43) Pub. Date: Feb. 12, 2026

(54) OPTICAL EQUIPMENT WITH INSULATED CHAMBER

(71) Applicant: SAMSUNG ELECTRONICS CO., LTD., Suwon-si (KR)

(72) Inventors: Ye Eun PARK, Suwon-si (KR); Jin Woo AHN, Suwon-si (KR); Seung Woo LEE, Suwon-si (KR); Jong Yeol YIM, Suwon-si (KR)

(73) Assignee: SAMSUNG ELECTRONICS CO., LTD., Suwon-si (KR)

(21) Appl. No.: 19/007,175

(22) Filed: Dec. 31, 2024

(30) Foreign Application Priority Data
Aug. 6, 2024 (KR) 10-2024-0104548

(51) Int. Cl. G02B 7/02

(52) U.S. Cl. CPC G02B 7/028

(57) ABSTRACT

Optical equipment may include: an optical component; an insulated chamber surrounding the optical component; a temperature controller within the insulated chamber; and a controller configured to control the temperature controller, wherein the controller is configured to, by controlling the temperature controller to control a temperature of a fluid introduced into the insulated chamber, cause a temperature of the optical component to be adjusted based on the fluid passing by the optical component as the fluid exits the insulated chamber.

### CROSS-REFERENCE TO RELATED APPLICATION

This application claims priority from Korean Patent Application No. 10-2024-0104548, filed on Aug. 6, 2024 in the Korean Intellectual Property Office, and all the benefits accruing therefrom under 35 U.S.C. 119, the contents of which in its entirety are herein incorporated by reference.

### BACKGROUND

### 1. Field

Embodiments of the present disclosure relate to optical equipment with an insulated chamber.

### 2. Description of Related Art

Objective lenses are used in various optical equipment (e.g., measuring equipment, exposure equipment, etc.) and are components directly related to the performance of the optical equipment. To measure or pattern fine patterns, the repeatability of the optical equipment needs to be improved, and for this purpose, the constancy of the objective lenses is important. After the objective lenses are fabricated, one of the factors that significantly affect the performance changes of the objective lenses is the temperature of the objective lenses.

### SUMMARY

According to embodiments of the present disclosure, optical equipment that maintains the constancy of optical components is provided.

According to embodiments of the present disclosure, optical equipment may be provided and include: an optical component; an insulated chamber surrounding the optical component; a temperature controller within the insulated chamber; and a controller configured to control the temperature controller, wherein the controller is configured to, by controlling the temperature controller to control a temperature of a fluid introduced into the insulated chamber, cause a temperature of the optical component to be adjusted based on the fluid passing by the optical component as the fluid exits the insulated chamber.

According to embodiments of the present disclosure, optical equipment may be provided and include: an equipment chamber; a stage within the equipment chamber, the stage configured have a substrate placed thereon; an objective lens above the stage; an insulated chamber surrounding the objective lens and including a first inlet; an optical system outside of the insulated chamber and connected to the objective lens; a first heater within the insulated chamber; a fluid supply configured to supply a fluid into the insulated chamber through the first inlet at a constant flow rate; and a controller configured to control at least one from among the first heater and the fluid supply, wherein the controller is configured to, by controlling the first heater to heat the fluid introduced into the insulated chamber through the first inlet, cause a temperature of the objective lens to be adjusted based on the fluid passing by the objective lens as the fluid exits the insulated chamber.

According to embodiments of the present disclosure, optical equipment may be provided and include: an insulated chamber including a top surface including a first through hole, a bottom surface including a second through hole, and a plurality of sidewalls connecting the top surface and the bottom surface, wherein the plurality of sidewalls include a first sidewall including an inlet, a second sidewall including a third through hole, and a third sidewall including a fourth through hole; an objective lens within the insulated chamber, wherein a portion of the objective lens is exposed through the second through hole; a heater within the insulated chamber, the heater being closer than the objective lens to the inlet, and connected to a power line through the third through hole; an optical system outside the insulated chamber and connected to the objective lens through the first through hole; a fluid supply configured to supply a fluid into the insulated chamber at a constant flow rate through the inlet; a temperature sensor within the fourth through hole and configured to sense a temperature inside the insulated chamber; and a controller configured to control power supplied to the heater based on a sensing value from the temperature sensor.

However, aspects and effects of embodiments of the present disclosure are not restricted to those set forth above. The above and other aspects and effects of embodiments of the present disclosure will become more apparent to one of ordinary skill in the art to which the present disclosure pertains by referencing the detailed description of the present disclosure given below.

### BRIEF DESCRIPTION OF DRAWINGS

The above and other aspects and features of embodiments of the present disclosure will become more apparent by describing in detail non-limiting example embodiments of the present disclosure with reference to the attached drawings, in which:

FIG. 1 is a block diagram illustrating optical equipment according to some embodiments of the present disclosure;

FIG. 2 is a conceptual diagram illustrating a configuration for maintaining the constancy of an optical component according to some embodiments of the present disclosure;

FIGS. 3 and 4 are diagrams illustrating a first embodiment that implements the configuration of FIG. 2 according to some embodiments of the present disclosure;

FIG. 5 is a diagram illustrating a second embodiment that implements the configuration of FIG. 2 according to some embodiments of the present disclosure;

FIG. 6 is a diagram illustrating a third embodiment that implements the configuration of FIG. 2 according to some embodiments of the present disclosure;

FIGS. 7 and 8 are diagrams illustrating a fourth embodiment that implements the configuration of FIG. 2 according to some embodiments of the present disclosure;

FIG. 9 is a block diagram illustrating optical equipment according to some embodiments of the present disclosure;

FIG. 10 is a diagram illustrating an embodiment that implements the optical equipment of FIG. 9 according to some embodiments of the present disclosure;

FIG. 11 is a diagram illustrating an example control method for maintaining constancy of an optical component in an optical equipment according to some embodiments of the present disclosure; and

FIG. 12 is a diagram illustrating effects of the optical equipment according to some embodiments of the present disclosure.

### DETAILED DESCRIPTION

Non-limiting example embodiments of the present disclosure will hereinafter be described with reference to the accompanying drawings. The same reference numerals are used for the same components in the drawings, and redundant descriptions thereof may be omitted.

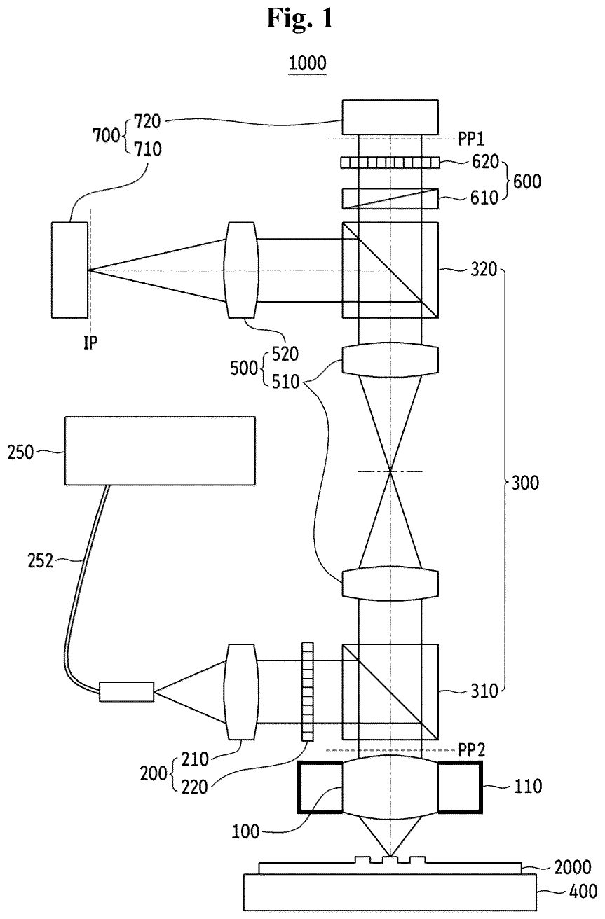

FIG. 1 is a block diagram illustrating optical equipment 1000 according to some embodiments of the present disclosure. Examples of the optical equipment 1000 include measuring equipment and exposure equipment, and FIG. 1 illustrates a pupil ellipsometry apparatus, but embodiments of the present disclosure are not limited thereto.

Referring to FIG. 1, the optical equipment 1000 may include a light source unit 250, an illumination optical system 200, an objective lens 100, a beam splitter unit 300, a stage 400, a relay optical system 500, a self-interference generator (SIG) 600, and a detector unit 700.

The light source unit 250 may generate light of a required wavelength band and input it into the illumination optical system 200. The light source unit 250 may generate and output coherent light. Here, the coherent light refers to light that causes interference, such as constructive interference or destructive interference, due to phase differences when two or more beams overlap. For example, the light source unit 250 may include a light source and a monochromator. The light source may generate and output broadband light. The monochromator may convert the broadband light into monochromatic light and output the monochromatic light. The light source unit 250 may operate such that the monochromator converts the broadband light from the light source into monochromatic light of the required wavelength band and outputs the monochromatic light. In some embodiments, the light source unit 250 may also be configured to include a plurality of point sources that output monochromatic light.

The illumination optical system 200 and the objective lens 100 may irradiate a measurement target 2000 with light that has been incident from the light source unit 250 through the optical fiber 252 using various optical elements.

The illumination optical system 200 may include, for example, a collimator 210 and a first polarizer 220. The collimator 210 may convert the incident monochromatic light into parallel light and output the parallel light. The first polarizer 220 may polarize the light from the collimator 210 and output the polarized light. This polarization may be, for example, linear polarization. Here, the linear polarization may refer to converting light into linearly polarized light by allowing only the p-polarized component (or horizontal component) or the s-polarized component (or vertical component) of incident light to pass through. In some embodiments, the first polarizer 220 may also perform circular polarization or elliptical polarization.

The objective lens 100 may focus the light from a first beam splitter 310, of the beam splitter unit 300, onto the measurement target 2000 and cause it to be incident. An incident angle θ of the light focused by the objective lens 100 may be determined by the numerical aperture (NA) of the objective lens 100. That is, when the refractive index of air is 1, the NA of the objective lens 100 may satisfy the following equation: NA=sinθ. Therefore, the closer the NA of the objective lens 100 is to 1, the closer the incident angle θ may become to 90°. Due to the focusing action of the objective lens 100, light components incident through different positions of the objective lens 100 may have different incident angles and azimuths. A second detector 720 of the detector unit 700 may detect an image (i.e., a pupil image) at a first pupil plane PP1 with respect to the measurement target 2000. Pixels of the pupil image correspond to different positions of the objective lens 100, and may contain reflectance information for light components incident through different positions of the objective lens 100, which have different incident angles and azimuths.

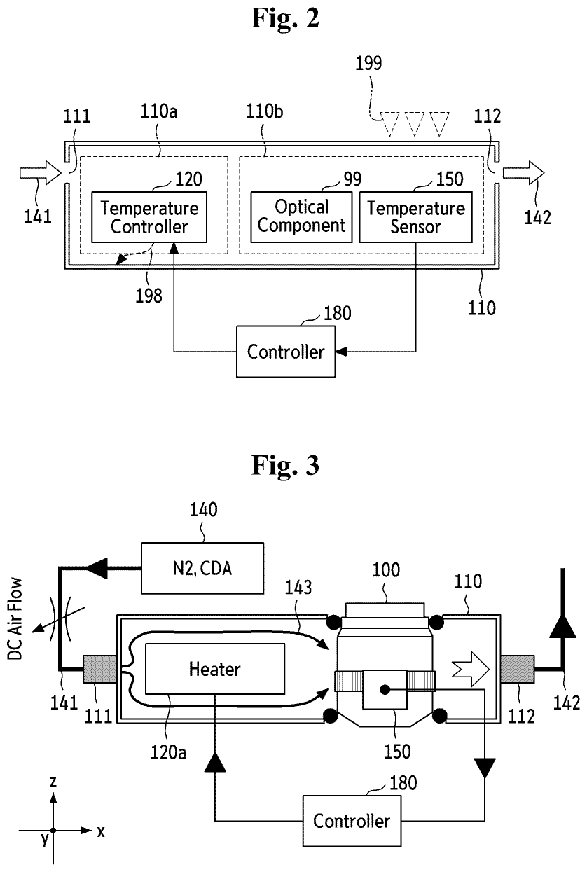

Particularly, in some embodiments, the objective lens 100 is surrounded by an insulated chamber 110 (see FIGS. 2-6). A temperature controller (e.g., a heater, a cooler, etc.) may be installed within the insulated chamber 110, and fluid may be supplied into the insulated chamber 110. The temperature of the supplied fluid may be controlled by the temperature controller. As the fluid with controlled temperature exits the insulated chamber 110, passing through the objective lens 100 the temperature of the objective lens 100 is adjusted to a reference temperature. A constancy maintenance method of the objective lens 100 will be described later in further detail with reference to FIGS. 2 through 12.

Meanwhile, reflected light from the measurement target 2000 may be incident on the first beam splitter 310 through the objective lens 100.

The beam splitter unit 300 may include the first beam splitter 310 and a second beam splitter 320. The first beam splitter 310 may emit the polarized light from the first polarizer 220 toward the objective lens 100 and may emit the reflected light from the measurement target 2000, which is incident upon the first beam splitter 310 through the objective lens 100, toward the second beam splitter 320. The second beam splitter 320 may emit some of the light from the first beam splitter 310 toward a first detector 710 of the detector unit 700 and some of the light from the first beam splitter 310 toward the SIG 600.

The stage 400 may support and fix the measurement target 2000. For example, the measurement target 2000 may be disposed on the upper surface of the stage 400, and the stage 400 may support and fix the lower surface of the measurement target 2000. The stage 400 may be a three-dimensional (3D) moving stage capable of moving in three dimensions. As the stage 400 moves, the measurement target 2000 may also move along with the stage 400. For example, through the movement of the stage 400, the focusing of the measurement target 2000 along a z-axis and/or the movement of the measurement target 2000 along an xy-plane may be performed. Here, the z-axis corresponds to the normal perpendicular to the upper surface of the stage 400 or the measurement target 2000, and the xy-plane corresponds to the upper surface of the stage 400 or the measurement target 2000, or to a plane perpendicular to the z-axis.

Meanwhile, the measurement target 2000 may be, for example, a mask or wafer that includes a pattern. Additionally, the measurement target 2000 may be a semiconductor device that includes a plurality of pattern layers or overlay marks. The optical equipment 1000 may measure and analyze various characteristics of the measurement target 2000. For example, the polarized light emitted through the first polarizer 220 may have its polarization state changed according to the condition of the measurement target 2000 as it is reflected from the measurement target 2000. Accordingly, the optical equipment 1000 can detect the reflected light from the measurement target 2000, analyze the polarization state of the detected light, and thereby measure and analyze various characteristics of the measurement target 2000, such as overlay error, pattern size, pattern thickness, and pattern uniformity. Moreover, the optical equipment 1000 of this embodiment can also detect defects such as pattern defects or foreign substances on the measurement target 2000.

The measurement and analysis of the measurement target 2000 may be performed by comparing reflectance information obtained through the second detector 720 and a holographic reconstruction process with reference information stored in a database. Furthermore, in some embodiments, the measurement and analysis of the measurement target 2000 may be performed through learning based on reflectance information for a plurality of measurement targets 2000 obtained through the optical equipment 1000.

The relay optical system 500 may transmit light from the objective lens 100 to the first detector 710 and the SIG 600. For example, the relay optical system 500 may include a relay lens 510 and an imaging lens 520. The relay lens 510 may comprise or consist of a pair of lenses and may transmit light from the first beam splitter 310 to the second beam splitter 320. The imaging lens 520 may form an image of the light from the second beam splitter 320 onto the first detector 710. The imaging lens 520 may be, for example, a tube lens.

The SIG 600 may generate interference light through self-interference of the light that is incident via the second beam splitter 320. Here, the light incident on the SIG 600 through the second beam splitter 320 may correspond to the reflected light from the measurement target 2000, which has been polarized by the first polarizer 220 and passed through the optical elements between the measurement target 2000 and the SIG 600. As described above, the polarized light from the first polarizer 220 may have its polarization state changed as it is reflected from the measurement target 2000. Thus, by detecting the reflected light and analyzing the polarization state of the detected light, various characteristics of the measurement target 2000 may be measured.

The SIG 600 may include a polarizing prism 610 and a second polarizer 620 to generate interference light through self-interference. The polarizing prism 610 may separate the incident light into light with different polarization states. For example, the polarizing prism 610 may separate and emit the incident light into vertically polarized light and horizontally polarized light. The polarizing prism 610 may be implemented as, for example, a Nomarski prism, a Wollaston prism, a Rochon prism, etc., but embodiments of the present disclosure are not limited thereto.

The second polarizer 620 may align two polarized beams separated by the polarizing prism 610 to have a common polarization component. For example, the second polarizer 620 may be a polarizer that passes therethrough an intermediate polarization component between vertical and horizontal polarization components, such as a 45° polarization component. Consequently, the vertically polarized light and horizontally polarized light from the polarizing prism 610 may pass through the second polarizer 620 as a common 45° polarization component. The two beams that have passed through the second polarizer 620 may self-interfere at a second pupil plane PP2 to generate interference light.

The detector unit 700 may include the first detector 710 and the second detector 720. The first detector 710 may detect an image of the reflected light formed on an imaging plane IP through the imaging lens 520. The first detector 710 may be a two-dimensional (2D) array detector, such as a charge-coupled device (CCD) camera, but embodiments of the present disclosure are not limited thereto. The first detector 710 may be disposed on the imaging plane IP and may be used to identify the measurement position for the measurement target 2000 and to determine the optimal focal position in an optical axis direction.

The second detector 720 may detect an image of the interference light (i.e., a hologram image) generated through self-interference by the SIG 600 at the second pupil plane PP2. Generally, when light is detected at the second pupil plane PP2, the intensity of the light may be accurately measured. Therefore, the second detector 720 may provide accurate measurement of the intensity of the hologram image. The second detector 720 may be implemented as, for example, a CCD camera or a photo-multiplier tube (PMT), but embodiments of the present disclosure are not limited thereto. The first pupil plane PP1 above the objective lens 100 may be referred to as a back focal plane, and the second pupil plane PP2 below the second detector 720 may be referred to as an exit pupil plane.

The hologram image may be created using the principles of holography. The principles of holography are as follows. Light from a light source is split into two beams. One of the two beams is reflected by a reference mirror and projected onto a screen, while the other beam is reflected by an object to be measured and also projected onto a screen. In this case, the light reflected by the reference mirror is referred to as a reference beam, and the light reflected by the object is referred to as an object beam. Since the object beam is reflected from the surface of the object, its phase varies depending on each position on the object's surface. Consequently, the reference beam and the object beam can interfere with each other, forming an interference pattern on the screen. This interference pattern image is referred to as a hologram image. A typical image only contains intensity information, but a hologram image can contain both intensity and phase information of light.

The optical equipment 1000 may detect a hologram image through self-interference using the SIG 600, instead of using an interference method of a reference beam and object beam via a reference mirror. Therefore, the configuration of the optical equipment 1000 may be simplified. Additionally, by detecting the hologram image at the second pupil plane PP2 through the second detector 720, the intensity of the hologram image may be measured more accurately. Consequently, reflectance information corresponding to the polarization characteristics of interference light may be calculated more accurately through a subsequent holographic reconstruction process. Furthermore, the optical equipment 1000 may use the objective lens 100 and its corresponding pupil image to obtain reflectance information for all azimuth angles and incident angles in a single shot. Therefore, the measurement target 2000 may be measured quickly and accurately without the need to adjust the incident angle and azimuth angle of the light incident on the measurement target 2000. Moreover, the optical equipment 1000 can address a cross-correlation problem where similar spectra appear for different parameter changes in a particular structure.

FIG. 2 is a conceptual diagram illustrating a configuration for maintaining the constancy of an optical component according to some embodiments of the present disclosure.

Referring to FIG. 2, the insulated chamber 110 may surround an optical component 99. The insulated chamber 110 may include an inlet 111, an outlet 112, a first internal space 110a, and a second internal space 110b.

The insulated chamber 110 may be a chamber with low thermal conductivity to minimize the influence of external atmospheric conditions. The material of the insulated chamber 110 may have a low thermal conductivity, and the thickness of the top surface, bottom surface, and sidewalls of the insulated chamber 110 may be configured as thick as possible. The area of the insulated chamber 110 may be minimized to accommodate only a temperature controller 120, the optical component 99, and a temperature sensor 150, which will be described later. Additionally, if the optical component 99 is an objective lens, the height of the insulated chamber 110 may be configured to allow the insulated chamber 110 to wrap around the objective lens as much as possible without obstructing the beam path of the objective lens to minimize the temperature gradient of the objective lens.

The inlet 111 may be for the fluid to enter the interior of the insulated chamber 110 from the outside (see fluid flow 141), and the outlet 112 may be for the fluid within the insulated chamber 110 to exit to the outside (see flow 142). The inlet 111 may be installed on one sidewall of the insulated chamber 110, and the outlet 112 may be installed on the other sidewall of the insulated chamber 110. Alternatively, contrary to what is illustrated in FIG. 2, the outlet 112 may not be provided. In this case, the fluid can escape through gaps in the insulated chamber 110.

The fluid may be either a gas or a liquid. The fluid may be a gas such as, for example, N₂ or clean dry air (CDA), but embodiments of the present disclosure are not limited thereto.

The first internal space 110a may be located closer than the second internal space 110b to the inlet 111.

The temperature controller 120 may be disposed in the first internal space 110a. The temperature controller 120 may be, for example, a heater for raising the temperature of the fluid, or a cooler for lowering the temperature of the fluid. When using a heater, the fluid may be introduced into the insulated chamber 110 at a temperature lower than a target temperature, and is then heated to the target temperature by the heater. When using a cooler, the fluid may be introduced into the insulated chamber 110 at a temperature higher than the target temperature, and is then cooled to the target temperature by the cooler.

Additionally, the temperature controller 120 may be positioned close to the optical component 99 within the insulated chamber 110 so that the fluid temperature-controlled by the temperature controller 120 has a minimized path to reach the optical component 99. Minimizing the path of the fluid provided a benefit of reducing heat loss during the fluid's movement.

The optical component 99 may be disposed in the second internal space 110b. The optical component 99 may be, for example, an objective lens 100 (see FIG. 1), a relay lens 510 (see FIG. 1), and/or a polarizing prism 610 (see FIG. 1).

The temperature sensor 150 may be installed in the second internal space 110b, but it is not limited to this location.

The temperature sensor 150 may be attached to the optical component 99 to sense the temperature of the optical component 99. Alternatively, the temperature sensor 150 may be installed to sense the temperature of the fluid within the insulated chamber 110 without being attached to the optical component 99.

Based on the sensing value from the temperature sensor 150, a controller 180 may control the temperature controller 120. For example, the controller 180 may control the on/off operation of the temperature controller 120, or may linearly adjust the output of the temperature controller 120. The controller 180 may include at least one processor, such as a central processing unit (CPU), graphic processing unit (GPU) and/or another type of microprocessor, and an internal memory to perform the above-described functions and the functions described herebelow by loading corresponding computer code or instructions on the internal memory and execute the computer code or instructions.

The controller 180 may ensure that the temperature of the fluid introduced into the insulated chamber 110 from the outside is controlled by the temperature controller 120 inside the insulated chamber 110. Subsequently, the controller 180 may ensure that the temperature of the optical component 99 is adjusted as the temperature-controlled fluid exits the insulated chamber 110, passing by (e.g., through) the optical component 99.

There are various methods for moving the fluid within the insulated chamber 110.

For example, a separate fluid supply system may be installed outside the insulated chamber 110. The fluid supply system may supply fluid into the insulated chamber 110 through the inlet 111. The fluid supply system may supply the fluid at a constant flow rate or may increase or decrease the fluid flow rate of the fluid based on sensing results. The flow rate adjustment of the fluid supply system may be performed by the controller 180.

Alternatively, a fan may be installed at the inlet 111 of the insulated chamber 110, and the fluid outside the insulated chamber 110 may be supplied into the insulated chamber 110 through the inlet 111 by driving the fan. The operation of the fan may be controlled by the controller 180.

Alternatively, an exhaust system may be installed outside the insulated chamber 110 to remove fluid from inside the insulated chamber 110. The exhaust system may be connected to the outlet 112 of the insulated chamber 110. When the exhaust system removes fluid inside the insulated chamber 110, fluid is drawn in through the inlet 111. The operation of the exhaust system may be controlled by the controller 180.

Adjusting the temperature of the optical component 99 provides the following advantages.

First, robustness against disturbance 199 can be achieved.

Specifically, since the optical component 99 may be located within an insulated chamber 110 that has a small size, the insulated chamber 110 can block the disturbance 199. Therefore, even if the external temperature of the insulated chamber 110 increases by 1° C., the temperature of the optical component 99 may be controlled not to increase by more than 0.01° C. For example, the temperature of the optical component 99 may be controlled to increase by no more than 0.005° C.

Moreover, by allowing fluid to flow within the insulated chamber 110, heat can be quickly transferred to the optical component 99.

Specifically, as described above, fluid is introduced into the insulated chamber 110, and the introduced fluid is heated and delivered to the optical component 99. The heated fluid adjusts the temperature of the optical component 99 and is then expelled from the insulated chamber 110.

Furthermore, allowing fluid to flow within the insulated chamber 110 enables quick dissipation of heat when the optical component 99 overheats. Since the insulated chamber 110 is isolated from the external environment, it is difficult to dissipate the heat within the insulated chamber 110 without fluid circulation.

Even when using a convection heater as the temperature controller 120, temperature control is possible due to a fast heat transfer. A convection heater can uniformly control the temperature of all surfaces of the optical component 99. If only natural convection occurs within the insulated chamber 110, heat transfer is slow, making real-time temperature control by a convection heater impossible. However, according to some embodiments of the present disclosure, by forcing fluid to flow within the insulated chamber 110, heat can be quickly transferred to the optical component 99 even when using a convection heater.

Additionally, heat loss can be minimized.

Specifically, since the temperature controller 120 is located within the insulated chamber 110, the physical distance to a target (e.g., the optical component 99) is short. Therefore, there is minimal heat loss during the process of the fluid reaching the optical component 99, as indicated by reference numeral 198. For example, if fluid heated externally is supplied to the target through a pipe, significant heat loss inevitably occurs as the fluid passes through the pipe. According to some embodiments of the present disclosure, as there is little heat loss due to external environment changes, similar performance can be achieved in any external environment.

Also, the optical component 99 can be temperature-controlled as a whole.

Specifically, according to some embodiments of the present disclosure, the fluid heated by the temperature controller 120 within the insulated chamber 110 flows while being in contact with the entirety of the optical component 99. Therefore, the temperature of the entirety of the optical component 99 can be controlled in a substantially uniform manner. If a contact heater is attached to one side of the optical component 99, the contact part of the optical component 99 may have a higher temperature than the non-contact part of the optical component 99.

In addition, the insulated chamber 110 can be made small enough to only surround the optical component 99 and the temperature controller 120. Therefore, the temperature of the fluid (e.g., N₂ or CDA) within the insulated chamber 110 can be quickly controlled by the temperature controller 120. As a result, the temperature of the optical component 99 can also be quickly adjusted by the temperature-controlled fluid. In other words, the temperature control of the optical component 99 can be performed rapidly.

Notably, the temperature of the optical component 99 can be stably controlled within a range of ±0.01°C. Specifically, the temperature of the optical component 99 can be stably controlled within a range of ±0.005°C.

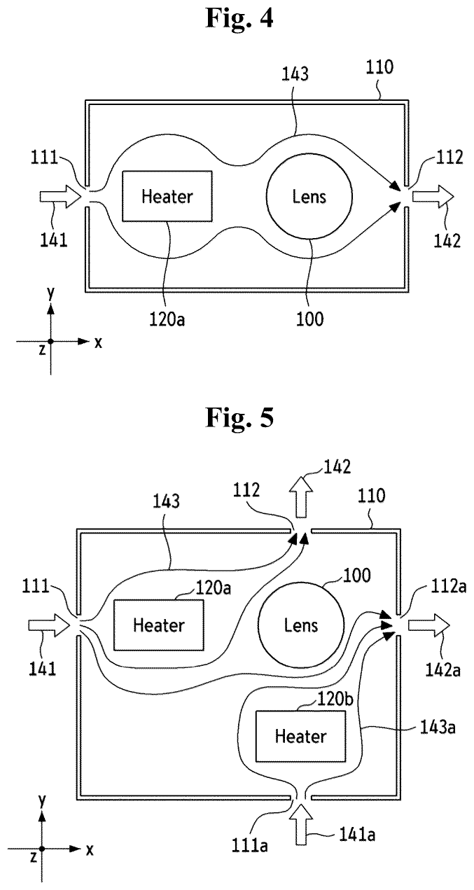

FIGS. 3 and 4 are diagrams illustrating a first embodiment that implements the configuration of FIG. 2 according to some embodiments of the present disclosure. For convenience, FIG. 3 illustrates an objective lens 100 (see FIG. 1) as an example of an optical component, but embodiments of the present disclosure are not limited thereto. For example, the optical component may be a relay lens 510 (see FIG. 1) or a polarizing prism 610 (see FIG. 1). Additionally, a heater 120a is illustrated as an example of the temperature controller 120, but embodiments of the present disclosure are not limited thereto.

Referring to FIGS. 3 and 4, an objective lens 100 may be surrounded by an insulated chamber 110. An inlet 111 may be installed on one side of the insulated chamber 110, and an outlet 112 may be installed on the opposite side of the insulated chamber 110. Within the insulated chamber 110, a heater 120a may be disposed between the objective lens 100 and the inlet 111.

A fluid supply unit 140 (e.g., a fluid supply) may supply fluid (e.g., N₂ or CDA) into the insulated chamber 110 at a constant flow rate, as indicated by reference numeral 141. The temperature of the fluid supplied by the fluid supply unit 140 may be lower than a target temperature. The supplied fluid may be heated to the target temperature by the heater 120a, and the heated fluid may then pass through the objective lens 100, as indicated by reference numeral 143, heating the objective lens 100. The temperature of the objective lens 100 may be adjusted to a reference temperature by the heated fluid. The fluid that has passed through the objective lens 100 may exit through the outlet 112, as indicated by reference numeral 142.

The temperature sensor 150 may be an attached sensor that is attached to the objective lens 100. The temperature sensor 150 may be attached to the objective lens 100 to sense the temperature of the objective lens 100. The controller 180 may be configured to control the heater 120a based on the sensing value from the temperature sensor 150. For example, if the sensing value is higher than a target value, the controller 180 may turn off the heater 120a, and if the sensing value is lower than the target value, the controller 180 may turn on the heater 120a.

Within the insulated chamber 110, the heater 120a and the objective lens 100 may be disposed side-by-side along a first direction (e.g., an x-axis direction). The objective lens 100 may extend in a third direction (e.g., a z-axis direction). The objective lens 100 may be connected to an optical system (e.g., a beam splitter, a relay lens, etc.) through an opening in the upper surface of the insulated chamber 110. The bottom of the objective lens 100 may be exposed through an opening in the bottom surface of the insulated chamber 110. Therefore, the bottom surface of the insulated chamber 110 may face a measurement target (e.g., a wafer) located below the objective lens 100.

FIG. 5 is a diagram illustrating a second embodiment that implements the configuration of FIG. 2 according to some embodiments of the present disclosure. For convenience, the second embodiment will hereinafter be described, focusing mainly on the differences from what has been described above with reference to FIGS. 2 through 4.

Referring to FIG. 5, a plurality of heaters (e.g., a first heater (e.g., the heater 120a) and a second heater 120b) may be installed inside the insulated chamber 110. A first inlet (e.g., the inlet 111) may be installed on a first sidewall of an insulated chamber 110, a second inlet 111a may be installed on a second sidewall of the insulated chamber 110, a first outlet (e.g., the outlet 112) may installed on a third sidewall of the insulated chamber 110, and a second outlet 112a may be installed on a fourth sidewall of the insulated chamber 110.

The first heater (e.g., the heater 120a) may be disposed closer than the objective lens 100 to the first inlet (e.g., the inlet 111), and the second heater 120b may be disposed closer than the objective lens 100 to the second inlet 111a. The objective lens 100 may be positioned closer than the first heater (e.g., the heater 120a) and the second heater 120b to the first outlet (e.g., the outlet 112) and the second outlet 112a.

Fluid may be introduced into the insulated chamber 110 through the first inlet (e.g., the inlet 111), as indicated by reference numeral 141, and may be heated by the first heater (e.g., the heater 120a). The heated fluid may then pass through the objective lens 100, as indicated by reference numeral 143, and may be expelled through the first outlet (e.g., the outlet 112) and/or the second outlet 112a, as indicated by reference numerals 142 and 142a.

Additionally, fluid may be introduced into the insulated chamber 110 through the second inlet 111a, as indicated by reference numeral 141a, and may be heated by the second heater 120b. The heated fluid may then pass through the objective lens 100, as indicated by reference numeral 143a, and may be expelled through the first outlet (e.g., the outlet 112) and/or the second outlet 112a, as indicated by reference numerals 142 and 142a.

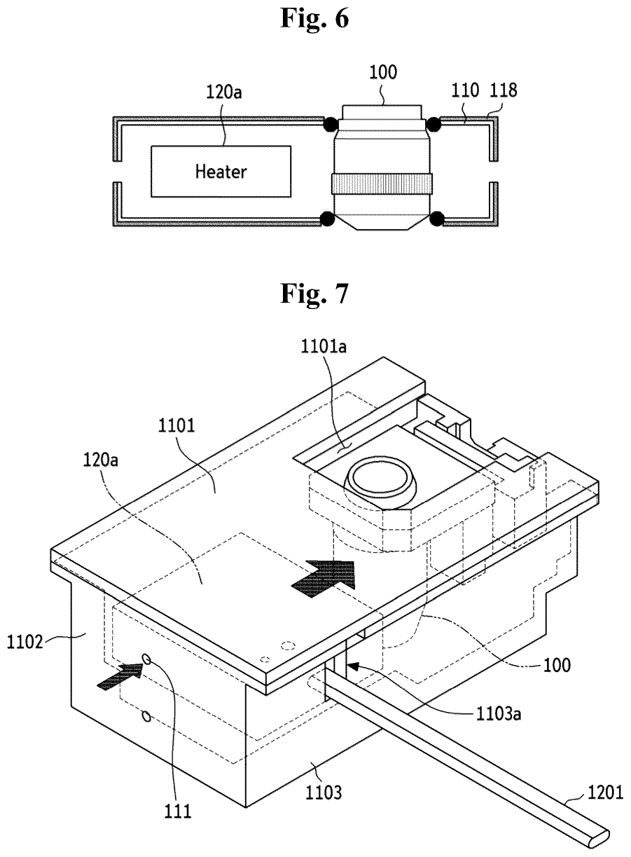

FIG. 6 is a diagram illustrating a third embodiment that implements the configuration of FIG. 2 according to some embodiments of the present disclosure. For convenience, the third embodiment will hereinafter be described, focusing mainly on the differences from what has been described above with reference to FIGS. 2 through 4.

Referring to FIG. 6, to enhance the insulation of the insulated chamber 110, insulation material 118 may be installed on at least one wall (e.g., the top surface, sidewalls, and/or bottom surface) of an insulated chamber 110. In FIG. 6, the insulation material 118 is illustrated as being formed on the outside of the insulated chamber 110, but embodiments of the present disclosure are not limited thereto. That is, the insulation material 118 may also be formed on the inside of the insulated chamber 110. The insulation material 118 may be formed of various materials, such as urethane, polystyrene, thermal reflective insulation, etc., but embodiments of the present disclosure are not particularly limited.

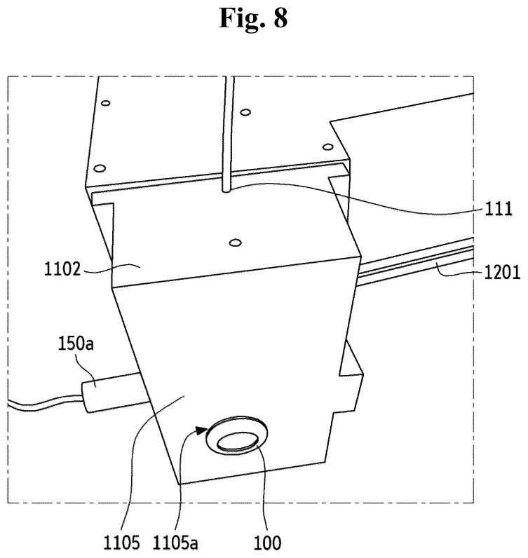

FIGS. 7 and 8 are diagrams illustrating a fourth embodiment that implements the configuration of FIG. 2 according to some embodiments of the present disclosure. FIG. 7 is a perspective view of an insulated chamber according to the fourth embodiment, as viewed from above, and FIG. 8 is a perspective view of the insulated chamber according to the fourth embodiment, as viewed from below.

Referring to FIGS. 7 and 8, an insulated chamber 110 (see FIG. 2) may include a top surface 1101, a bottom surface 1105, and a plurality of sidewalls. The sidewalls of the insulated chamber 110 may include a first sidewall 1102, a second sidewall 1103, and a third sidewall.

A first through hole 1101a may be formed in the top surface 1101. A second through hole 1105a may be formed in the bottom surface 1105. An objective lens 100 may be disposed inside the insulated chamber 110, and a part of the objective lens 100 may be exposed through the second through hole 1105a. The objective lens 100 may be connected to an optical system (e.g., a beam splitter, a relay lens, etc.) through the first through hole 1101a.

An inlet 111 may be formed in the first sidewall 1102. A fluid supply unit may supply fluid into the insulated chamber through the inlet 111.

A third through hole 1103a may be formed in the second sidewall 1103. A power line 1201 may be connected to the heater 120a through the third through hole 1103a.

The heater 120a may be disposed close to the inlet 111.

A fourth through hole may be formed in the third sidewall, and a temperature sensor 150a may be installed through the fourth through hole. That is, the temperature sensor 150a may be installed to penetrate the third sidewall. The temperature sensor 150a may sense the temperature inside the insulated chamber 110. A controller may control the heater 120a based on the sensing value from the temperature sensor 150a.

The fluid supplied through the inlet 111 may be heated by the heater 120a, and the heated fluid may adjust the temperature of the objective lens 100. The insulated chamber 110 may not have a separate outlet. In this case, the fluid that has passed through the objective lens 100 may escape through gaps in the insulated chamber 110.

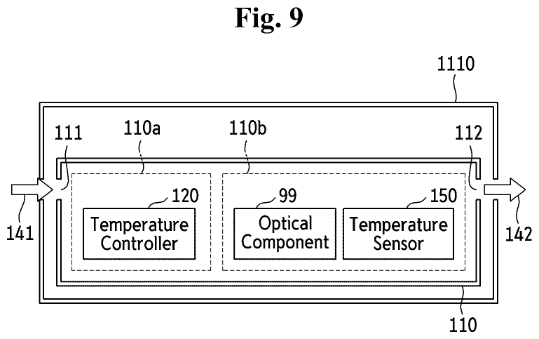

FIG. 9 is a block diagram illustrating optical equipment according to some embodiments of the present disclosure. For convenience, the embodiment of FIG. 9 will hereinafter be described, focusing mainly on the differences from what has been described above with reference to FIGS. 2 through 8.

Referring to FIG. 9, in the optical equipment according to some embodiments of the present disclosure, multiple different chambers, such as equipment chamber 1110 and an insulated chamber 110, may be included.

As described above, to maintain the constancy of an optical component 99, the insulated chamber 110 that surrounds the optical component 99 may be provided, and a temperature controller 120 (e.g., a heater or a cooler) may be located within the insulated chamber 110. A temperature sensor 150 may sense the temperature of the optical component 99 or the temperature inside the insulated chamber 110.

The equipment chamber 1110 may be formed to surround the insulated chamber 110.

Gas may be introduced from the outside into the equipment chamber 1110, and this gas may be further introduced into the insulated chamber 110, as indicated by reference numeral 141. The gas temperature-controlled by the temperature controller 120 inside the insulated chamber 110 may adjust the temperature of the optical component 99. Thereafter, the gas may be expelled to the outside of both the insulated chamber 110 and the equipment chamber 1110, as indicated by reference numeral 142.

In this manner, since the optical component 99 is surrounded by multiple chambers (e.g., the insulated chamber 110 and the equipment chamber 1110) its constancy can be stably maintained.

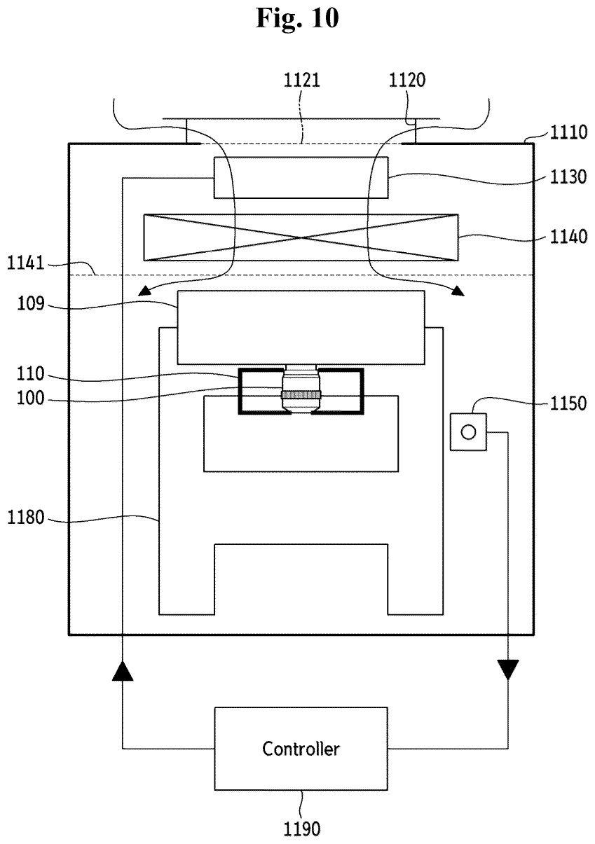

FIG. 10 is a diagram illustrating an embodiment that implements the optical equipment of FIG. 9 according to some embodiments of the present disclosure. For convenience, the embodiment of FIG. 10 will hereinafter be described, focusing mainly on the differences from what has been described above with reference to FIG. 9.

Referring to FIG. 10, a hole 1120 may be installed on one surface (e.g., the top surface) of the equipment chamber 1110, and a first filter 1121 may be installed near the hole 1120. Below the first filter 1121, a second filter 1141 may be installed. A heater 1130 and a fan 1140 may be installed between the first filter 1121 and the second filter 1141.

Gas may be introduced into the equipment chamber 1110 through the hole 1120, and the introduced gas may be filtered primarily by the first filter 1121 and then heated by the heater 1130. The fan 1140 may direct the heated gas toward the second filter 1141. The gas may then be filtered secondarily by the second filter 1141.

A temperature sensor 1150 may be installed inside the equipment chamber 1110 and sense the temperature inside the equipment chamber 1110. A controller 1190 may receive the sensing value from the temperature sensor 1150 and control the heater 1130. For example, if the sensing value from the temperature sensor 1150 is lower than a target value, the controller 1190 may turn on the heater 1130, and if the sensing value from the temperature sensor 1150 is higher than the target value, the controller 1190 may turn off the heater 1130.

Inside the equipment chamber 1110, a stage 1180 on which a substrate is placed may be disposed. Above the stage 1180, an objective lens 100 and an optical system 109 connected to the objective lens 100 may be installed.

As described above, the insulated chamber 110 may be installed to maintain the constancy of the objective lens 100, and the temperature controller 120 and the temperature sensor 150 may be disposed within the insulated chamber 110. The temperature controller 120 may be a convection heater. A fluid supply unit that supplies fluid into the insulated chamber 110 at a constant flow rate may be further installed. A controller may control the temperature controller 120 based on the sensing value from the temperature sensor 150. This controller may also control the fluid supply unit. The controller may be configured to ensure that the fluid introduced into the insulated chamber 110 through the inlet is heated by the temperature controller 120 (or the heater 120a) and controls the temperature of the objective lens 100 as the heated fluid exits the insulated chamber 110, passes through the objective lens 100 (or the optical component 99).

The controller that controls the temperature controller 120 and the controller 1190 that controls the heater 1130 may be implemented as a single system/module or as separate systems/modules.

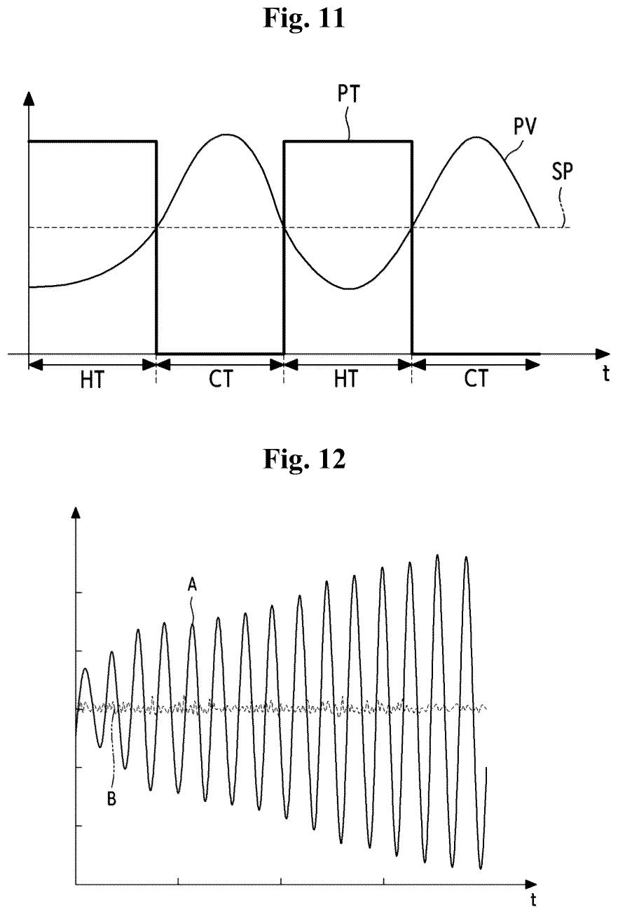

FIG. 11 is a diagram illustrating an example control method for maintaining the constancy of an optical component in an optical equipment according to some embodiments of the present disclosure.

Referring to FIGS. 2 and 11, a target value SP of the optical component 99, a current temperature PV of the optical component 99, and an output PT of the temperature controller 120 that indicates an on/off operation are indicated.

If the current temperature PV of the optical component 99 is lower than the target value SP, the output PT of the temperature controller 120 may be controlled to be on. The on state of the temperature controller 120 may be maintained during a heating period HT (or “on time”).

If the current temperature PV of the optical component 99 is higher than the target value SP, the output PT of the temperature controller 120 may be controlled to be off. The off state of the temperature controller 120 may be maintained during a cooling period CT (or “off time”).

The length of the heating period HT and the length of the cooling period CT may be substantially the same as each other. That is, the ratio of the heating period HT to the cooling period CT may be 1:1. Alternatively, the ratio of the heating period HT to the cooling period CT may be between 4:6 and 6:4. For example, the ratio of the heating period HT to the cooling period CT may be 40:60, 45:55, 50:50, 55:45, or 60:40.

In some embodiments of the present disclosure, fluid may be forced to flow inside the insulated chamber 110 by the fluid supply unit. Therefore, even if a convection heater is used as the temperature controller 120, rapid heat transfer may be achieved, enabling temperature control within the insulated chamber 110.

On the other hand, if there is no fluid flow inside the insulated chamber 110, the heat within the insulated chamber 110 may not dissipate easily. In this case, the heating period HT may be shortened, and the cooling period CT may become significantly longer. For example, the cooling period CT may be at least twice as long as the heating period HT.

FIG. 12 is a diagram illustrating effects of the optical equipment according to some embodiments of the present disclosure.

Referring to FIGS. 2 and 12, the x-axis represents time, and the y-axis represents temperature. Here, an external temperature A of the insulated chamber 110, and a temperature B of the optical component 99 (e.g., the objective lens 100) are indicated.

It can be observed that the amplitude of external temperature fluctuations of the insulated chamber 110 gradually increases over time. In contrast, it can be confirmed that the amplitude of temperature fluctuations in the optical component 99 remains constant. The temperature of the optical component 99 is observed to vary within a range of ±0.005° C. from the initial temperature.

According to some embodiments of the present disclosure, by minimizing the temperature fluctuations of the optical component 99, the repeatability of the optical equipment (e.g., measuring equipment, exposure equipment, etc.) can be improved.

While non-limiting example embodiments of the present disclosure have been described above with reference to the accompanying drawings, embodiments of the present disclosure are not limited to the above example embodiments and may be embodied in various other forms. Those skilled in the art to which the present disclosure pertains will understand that various modifications and changes can be made to the embodiments without departing from the spirit and scope of the present disclosure. Therefore, it should be understood that the example embodiments described above are illustrative in all aspects and not restrictive.

What is claimed is:

1. Optical equipment comprising:
an optical component;
an insulated chamber surrounding the optical component;
a temperature controller within the insulated chamber; and
a controller configured to control the temperature controller,
wherein the controller is configured to, by controlling the temperature controller to control a temperature of a fluid introduced into the insulated chamber, cause a temperature of the optical component to be adjusted based on the fluid passing by the optical component as the fluid exits the insulated chamber.

2. The optical equipment of claim 1, wherein an inlet is on one sidewall of the insulated chamber,
wherein the temperature controller is in a first internal space of the insulated chamber, and the optical component is in a second internal space of the insulated chamber, and
wherein the first internal space is closer than the second internal space to the inlet.

3. The optical equipment of claim 1, further comprising:
a temperature sensor within the insulated chamber,
wherein the controller is further configured to control the temperature controller based on a sensing value from the temperature sensor.

4. The optical equipment of claim 3, wherein the temperature sensor is attached to the optical component to sense the temperature of the optical component or the temperature of the fluid within the insulated chamber.

5. The optical equipment of claim 3, wherein the controller is further configured to control the temperature of the fluid within the insulated chamber by turning on or off the temperature controller, and
wherein a ratio of an on-time to an off-time of the temperature controller is 1:1.

6. The optical equipment of claim 1, wherein the optical component comprises at least one from among an objective lens, a relay lens, and a prism.

7. The optical equipment of claim 1, further comprising:
a fluid supply configured to supply the fluid into the insulated chamber through an inlet of the insulated chamber at a constant flow rate.

8. The optical equipment of claim 1, further comprising:
a fan at an inlet of the insulated chamber,
wherein the fan is configured to draw the fluid is drawn from an outside to an inside of the insulated chamber through the inlet.

9. The optical equipment of claim 1, further comprising:
an exhaust system configured to remove the fluid from within the insulated chamber to an outside of the insulated chamber.

10. The optical equipment of claim 1, wherein the insulated chamber comprises an outlet or a gap that is configured to discharge the fluid, which is temperature-controlled.

11. The optical equipment of claim 1, wherein the temperature controller is a heater.

12. The optical equipment of claim 1, wherein the temperature controller is a cooler.

13. The optical equipment of claim 1, further comprising:
an optical system outside of the insulated chamber and connected to the optical component.

14. Optical equipment comprising:
an equipment chamber;
a stage within the equipment chamber, the stage configured have a substrate placed thereon;
an objective lens above the stage;
an insulated chamber surrounding the objective lens and comprising a first inlet;
an optical system outside of the insulated chamber and connected to the objective lens;
a first heater within the insulated chamber;
a fluid supply configured to supply a fluid into the insulated chamber through the first inlet at a constant flow rate; and
a controller configured to control at least one from among the first heater and the fluid supply,
wherein the controller is configured to, by controlling the first heater to heat the fluid introduced into the insulated chamber through the first inlet, cause a temperature of the objective lens to be adjusted based on the fluid passing by the objective lens as the fluid exits the insulated chamber.

15. The optical equipment of claim 14, wherein the first inlet is in a first sidewall of the insulated chamber,
wherein the first heater is in a first internal space of the insulated chamber, and the objective lens is in a second internal space of the insulated chamber, and
wherein the first internal space is closer than the second internal space to the first inlet.

16. The optical equipment of claim 15, wherein the insulated chamber comprises a gap that is configured to discharge the fluid that is heated.

17. The optical equipment of claim 14, further comprising:
a first temperature sensor that penetrates a second sidewall of the insulated chamber,
wherein the controller is further configured to control the first heater based on a sensing value from the first temperature sensor.

18. The optical equipment of claim 14, wherein the first heater is a convection heater.

19. The optical equipment of claim 14, wherein the equipment chamber further comprises:
a second inlet configured to supply gas into the equipment chamber;
a second heater configured to heat the gas; and
a second temperature sensor configured to sense a temperature within the equipment chamber,
wherein the controller is further configured to control the second heater based on a sensing value from the second temperature sensor.

20. Optical equipment comprising:
an insulated chamber comprising a top surface comprising a first through hole, a bottom surface comprising a second through hole, and a plurality of sidewalls connecting the top surface and the bottom surface, wherein the plurality of sidewalls comprise a first sidewall comprising an inlet, a second sidewall comprising a third through hole, and a third sidewall comprising a fourth through hole;
an objective lens within the insulated chamber, wherein a portion of the objective lens is exposed through the second through hole;
a heater within the insulated chamber, the heater being closer than the objective lens to the inlet, and connected to a power line through the third through hole;
an optical system outside the insulated chamber and connected to the objective lens through the first through hole;
a fluid supply configured to supply a fluid into the insulated chamber at a constant flow rate through the inlet;
a temperature sensor within the fourth through hole and configured to sense a temperature inside the insulated chamber; and
a controller configured to control power supplied to the heater based on a sensing value from the temperature sensor.
